(19) United States
(12) Patent Application Publication
(10) Pub. No.: US 2014/0358637 A1
(43) Pub. Date: Dec. 4, 2014

(54) METHOD AND SYSTEM FOR GRAPHICALLY PRESENTING A SURVEY INTERFACE TO A USER

(71) Applicant: TGG Ventures LLC, Chicago, IL (US)

(72) Inventors: Daniel Kahneman, Princeton, NJ (US); Andrew Rosenfield, Lake Forest, IL (US); Thomas Blaser, Chicago, IL (US); Andrew Hogue, Chicago, IL (US); Sanjay Misra, Chicago, IL (US)

(73) Assignee: TGG Ventures LLC, Chicago, IL (US)

(21) Appl. No.: 14/290,773

(22) Filed: May 29, 2014

Related U.S. Application Data
(60) Provisional application No. 61/829,699, filed on May 31, 2013.

(51) Int. Cl. G06Q 30/02; G06F 3/0484; H04L 12/24

(52) U.S. Cl. CPC G06Q 30/0203; H04L 41/22; G06F 3/04847
USPC 705/7.32

(57) ABSTRACT

A method and system for graphically presenting a survey interface to a user. The method and system include graphically presenting the user with an inquiry and a corresponding user interface input slider via a self normalizing survey interface application, wherein the user interface input slider includes a user interface input marker. The method and system also include recording the inquiry response position of the user interface input marker on the user interface input slider selected by the user in response to the inquiry as a response data value. Additionally, the method and system include presenting the user with a subsequent inquiry and corresponding user interface input slider, wherein the user interface input marker is positioned at a self normalizing position that corresponds to the inquiry response position selected by the user during one or more prior survey sessions.

### BACKGROUND OF INVENTION

1. Field of Invention

Surveys with rating scales are a common way for data gatherers such as public and private entities that include governments, businesses, media outlets, pollsters, and/or researchers to quantify and aggregate qualitative data. These surveys are utilized to capture qualitative data that can be indicative of, but not limited to the user's opinions, ideas, thoughts, answers, beliefs, views, and attitudes towards many number of different topics, statements, and/or questions. The qualitative data gathered can be further computed into categories of survey data that include satisfaction data, sentiment data, opinion data, judgment data, etc.

2. Description of Related Art

A common format of most surveys includes a plurality of user interface radio buttons (i.e., circular radian buttons), user interface check boxes, and/or drop down menus that correspond to each answer placed next to statements/questions that are presented to the user as blank/unanswered. These types of surveys can be inputted (e.g., checked, highlighted, or selected) by the user to provide one or more selections. In most instances these user interface surveys use a type of rating scale as a mechanism to record the user's responses. For example, some surveys use scales that correspond to a specific value of agreement between strongly disagree and strongly agree. Other surveys use numeric scales (1 to 10) or scales based on sentiment (happy or sad face images).

Some surveys will vary the questions a user receives based on known characteristics of the user. For example, a company may ask questions that are highly specific to a product in a user's purchase history. Additionally, some surveys may be provided to the user again at a later point in time or may be provided with related follow up questions based on responses to certain questions. For example, a survey may be reshown and provided after a version change in a model of a product (e.g., mobile phone), or a policy (e.g., a political/government/corporate policy) to determine if a user's sentiments about the product or policy have improved or worsened since the user completed the survey that was applicable to the last version of the product or policy.

Currently, the presentation, format, and internal structure of questions within the reshown survey does not change based on a user's past survey responses. Users are presented with a blank reshown survey that does not reflect the user's past position provided in the survey at an earlier point in time. The reshown survey is utilized by the user independently of the past survey and the data is analyzed separately by data gatherers. This limitation can restrain the capturing of fluid, rolling, and/or aggregate quantitative data that can be utilized in a much broader fashion to understand changes in the user's opinions, ideas, thoughts, answers, beliefs, views, and attitudes based on specific events, and/or over a period of time.

### BRIEF SUMMARY OF THE INVENTION

According to one aspect, a method for presenting a survey interface to a user. The method includes during a survey session, graphically presenting the user with an inquiry and a corresponding user interface input slider via a self normalizing survey interface application. The user interface input slider includes a user interface input marker configured to be selectively positioned at one of a plurality of inquiry response positions by the user as an inquiry response. The method additionally includes recording the inquiry response position of the user interface input marker on the user interface input slider selected by the user in response to the inquiry as a response data value. The method also includes in a subsequent survey session of the user via the self normalizing survey interface application, presenting the user with a subsequent inquiry and corresponding user interface input slider. The user interface input marker is positioned at a self normalizing position that corresponds to the inquiry response position selected by the user during one or more prior survey sessions of the self normalizing survey interface application. Additionally, the method includes recording the inquiry response position of the user interface input marker on the user interface input slider selected by the user in response to the subsequent inquiry as a subsequent inquiry response data value to be utilized during one or more subsequent survey sessions of the self normalizing survey interface application.

According to a further aspect, a system for graphically presenting a survey interface to a user. Specifically in accordance with this aspect, the system includes a a self normalizing survey interface application that is executed on a plurality of electronic devices. The system also includes a survey user interface that is included as a user interface of the self normalizing server interface application for graphically presenting the user with an inquiry and a corresponding user interface input slider during a survey session. The user interface input slider includes a user interface input marker configured to be selectively positioned at one of a plurality of inquiry response positions by the user as an inquiry response. The system also includes a survey marker reception module that is included as a module of the self normalizing server interface application that records the inquiry response position of the user interface input marker on the user interface input slider selected by the user in response to the inquiry as a response data value. The system additionally includes a survey marker position output module that is included as a module of the self normalizing server interface application that presents the user with a subsequent inquiry and corresponding user interface input slider during a subsequent survey session. The user interface input marker is positioned at a self normalizing position that corresponds to the inquiry response position selected by the user during one or more prior survey sessions with the self normalizing survey interface application. The survey marker reception module records the inquiry response position of the user interface input marker on the user interface input slider selected by the user in response to the subsequent inquiry as a subsequent inquiry response data value to be utilized during one or more subsequent survey sessions of the self normalizing survey interface application.

According to still another aspect, a computer readable medium including instructions that when executed by a processor execute a method for presenting a survey interface to a user. The method includes during a survey session, graphically presenting the user with an inquiry and a corresponding user interface input slider via a self normalizing survey interface application. The user interface input slider includes a user interface input marker configured to be selectively positioned at one of a plurality of inquiry response positions by the user as an inquiry response. The method additionally includes recording the inquiry response position of the user interface input marker on the user interface input slider selected by the user in response to the inquiry as a response data value. The method also includes in a subsequent survey session of the user via the self normalizing survey interface application, presenting the user with a subsequent inquiry and corresponding user interface input slider. The user interface input marker is positioned at a self normalizing position that corresponds to the inquiry response position selected by the user during one or more prior survey sessions of the self normalizing survey interface application. Additionally, the method includes recording the inquiry response position of the user interface input marker on the user interface input slider selected by the user in response to the subsequent inquiry as a subsequent inquiry response data value to be utilized during one or more subsequent survey sessions of the self normalizing survey interface application.

### BRIEF DESCRIPTION OF THE DRAWINGS

In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary self normalizing survey interface system for presenting a user interface input marker in a self normalizing inquiry response position on a user interface input slider;

FIG. 2A is an illustrative example of different user interface input sliders and default positions of the user interface input marker on the different user interface input sliders corresponding to different surveys;

FIG. 2B is illustrative example of different user interface input sliders and self normalizing inquiry response positions of the user interface input marker on the different user interface markers corresponding to different surveys;

FIG. 3 is a process flow diagram of an overview of exemplary details regarding the position of a user interface input marker during an initial survey session and a subsequent survey session;

FIG. 4 is a process flow diagram of a method utilized during an initial survey session of an exemplary embodiment of the self-normalizing survey interface application from the operating environment of FIG. 1 according to an embodiment;

FIG. 5 is a process flow diagram of a method utilized to record a response data value that corresponds to the position of the user interface input marker from a prior survey of an exemplary embodiment of the self-normalizing survey interface application from the operating environment of FIG. 1 according to an embodiment;

FIG. 6 is a process flow diagram of a method utilized during a subsequent survey session of an exemplary embodiment of the self-normalizing survey interface application from the operating environment of FIG. 1 according to an embodiment;

### DETAILED DESCRIPTION

Various terms are utilized throughout the specification and the appended claims. Unless otherwise specified expressly or by context, such terms are to be accorded the definitions set forth in the following paragraphs.

A “processor,” as used herein, processes signals and performs general computing and arithmetic functions. Signals processed by the processor can include digital signals, data signals, computer instructions, processor instructions, messages, a bit, a bit stream, or other computing that can be received, transmitted and/or detected.

A “bus,’ as used herein, refers to an interconnected architecture that is operably connected to transfer data between computer components within a singular or multiple systems. The bus can be a memory bus, a memory controller, a peripheral bus, an external bus, a crossbar switch, and/or a local bus, among others.

A “memory,” as used herein can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

An “operable connection,” as used herein can include a connection by which entities are “operably connected”, is one in which signals, physical communications, and/or logical communications can be sent and/or received. An operable connection can include a physical interface, a data interface and/or an electrical interface.

An “input device” as used herein can include devices for controlling different features which include various components, systems, and subsystems. The term “input device” includes, but it not limited to: push buttons, rotary knobs, and the like. The term “input device” additionally includes graphical input controls that take place within a user interface which can be displayed by various types of mechanisms such as software and hardware based controls, interfaces, or plug and play devices.

An “output device” as used herein can include devices that can derive from components, systems, subsystems, and electronic devices. The term “output devices” includes, but is not limited to: display devices, and other devices for outputting information and functions.

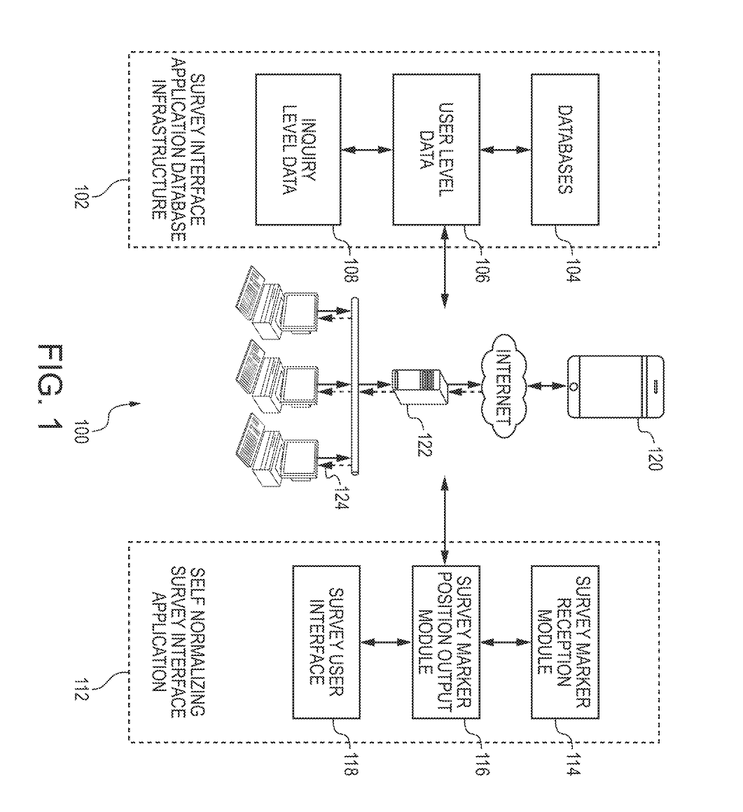

Referring now to the drawings, wherein the showings are for purposes of illustrating one or more exemplary embodiments and not for purposes of limiting the same. FIG. 1 shows schematic view of an exemplary operating environment of a self normalizing survey interface system 100 and exemplary methods according to an embodiment. The components of the self normalizing survey interface system 100, as well as the components of other systems, hardware architectures and software architectures discussed herein, can be combined, omitted or organized into different architecture for various embodiments. However, the exemplary embodiments discussed herein focus on the environment 100 as illustrated in FIG. 1, with corresponding system components, and related methods.

As shown in the illustrated embodiment of FIG. 1, the self normalizing survey interface system 100 provides an overview showing the communications and data transfers between a self normalizing survey interface application 112 and a survey interface application database infrastructure 102. In an exemplary embodiment, the self normalizing survey interface application 112 utilizes data that is recorded (i.e., saved) by the components of the self normalizing survey interface application 112 to be retained/stored within the components of the survey interface application database infrastructure 102 to be later accessed by the components of the self normalizing survey interface application 112 and displayed to a user.

Specifically, in an exemplary embodiment, the self normalizing survey interface application 112 presents a user with a survey user interface 118 that graphically presents the user with a survey that includes one or more underlying inquires provided by one or more data gathering institutions. The survey user interface 118 presents the one or more inquires with a corresponding user interface input slider that is located adjacent to each of the inquires. In addition, the survey user interface 118 also presents the user with a user input marker that is displayed to the user above (i.e., atop) the user interface input slider and can be moved by the user via scrolling, drag and drop, and/or other input means to provide an input that corresponds to one of a plurality of inquiry response positions. The user interface input slider can include a continuous rating scale line segment that can be labeled (i.e., represented by labels). The labels can include accompanying texts, colors, color gradients, numbers, icons, symbols, pictures and combinations thereof that are indicative of one or more inquiry responses.

The survey user interface 118 can display surveys in various forms that are in accordance with the user interface slider. During an initial survey session (i.e., the first presentation of the survey to the user via the self normalizing survey interface application 112), the user interface input marker is presented the user interface marker at a default starting response position of the user interface input slider. For example, if a user utilizes the self normalizing survey interface application 112 via the web, at the beginning of the first session, when the user is given a survey for the first time, the user interface input markers will be shown at a default response position at each of the user interface input sliders that correspond to each inquiry included within the survey.

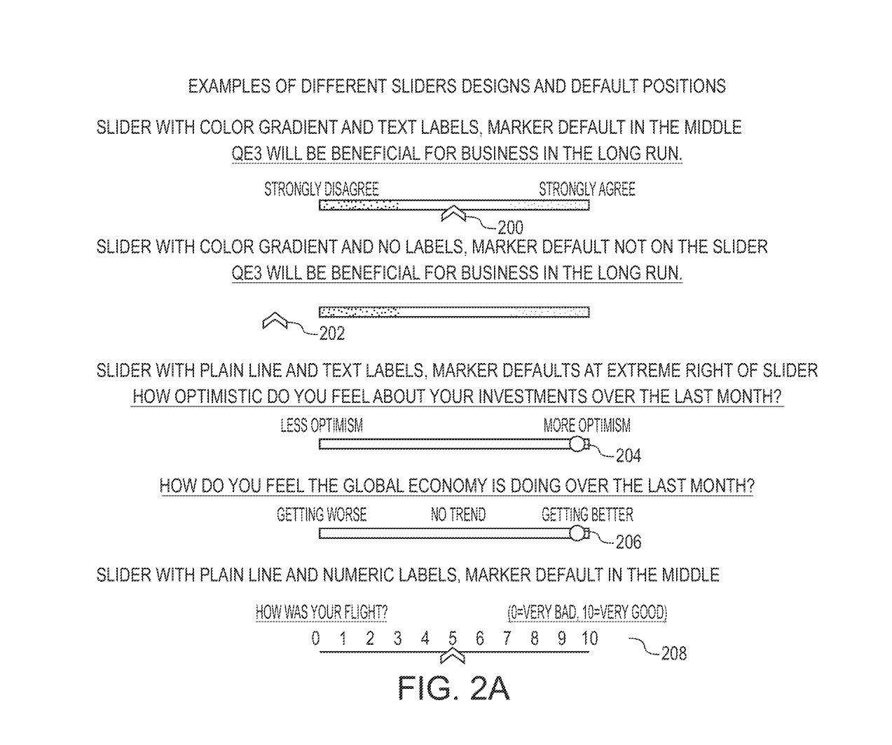

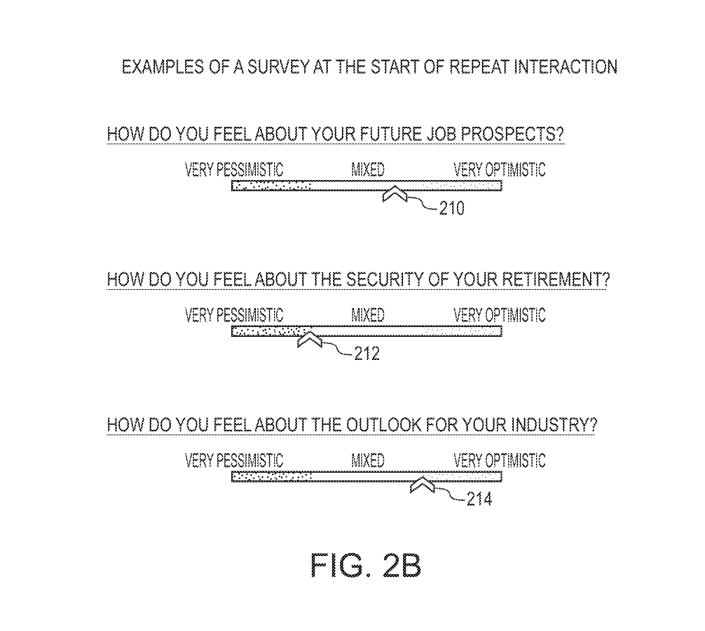

FIG. 2A is an illustrative example of different types of user interface input slider designs and default positions of the user interface input marker on the different types of user interface input sliders corresponding to different surveys. FIG. 2A demonstrates a limited set of the many possible configurations of a user interface session. In an exemplary embodiment the default position of the user interface input marker 200 can be in the middle of the scale of the user interface slider that is represented by labels that include text and color gradient. In an alternate embodiment, the default position of the user interface input marker 202 can be included separate from the slider entirely (i.e., the user could be required to drag the marker onto the slider), or absent (i.e., the user touches or marks the slider and the marker appears at that point). In one embodiment, the default position of the user interface input markers 204, 206 can be at an extreme end of the user interface slider(s) composed of a plain line that is represented by labels that includes text. In yet another embodiment, the user interface input slider 208 can be composed of a plain line that is represented by labels that include numeric values. In one embodiment, the default positions of user interface input markers for a given survey could be determined as a function of psychological principals, predictive analytics, or some other calculus designed to influence responses.

With reference back to FIG. 1, once the user places the user interface marker at a (final) inquiry response position of the user interface input slider, the self normalizing survey interface application 112 utilizes a survey marker reception module 114 to register and record a response as a response data value to be utilized by the self normalizing survey interface application 112. In order to register a response to the inquiry, a user must make contact with the user interface input marker, even if the position of the user interface input marker is not changed from a starting position that was presented to the user when the survey was first presented to the user. For example, if the user chooses to answer an inquiry response at the same inquiry response position as a position at which the user interface input marker was positioned when the user was presented the survey, the user can utilize a computer mouse to click input onto the user interface input slider to register a response to the inquiry at the same (starting) position, without having to move the user interface input marker.

The user can use the self normalizing survey interface application 112 during a subsequent survey session (that takes place at a later point in time) after the completion of the initial survey. In an exemplary embodiment, the subsequent survey includes the self normalizing survey interface application 112 presented to the user with a survey and one or more underlying inquires that were presented to and completed by the user at an earlier point in time. In an alternate embodiment, the self normalizing survey interface application 112 can present survey variants that include variants of specific inquires (e.g., spin offs, follow up questions, edited questions) that are related to inquires from prior survey sessions. For example, a survey can be presented with questions that are slightly changed from the last time the survey was taken.

After the survey maker reception module 114 records the response data value recorded during the (last) prior survey session, upon accessing the survey during a subsequent survey session, a survey marker position output module 116 of the self normalizing survey interface application 112 presents the user with the user interface input marker at a self normalizing position. The self normalizing position corresponds to the inquiry response position selected by the user during a prior survey session (that took place at an earlier point in time). FIG. 2B is illustrative example of different user interface input sliders and self normalizing inquiry response positions of the user interface input marker on the different user interface markers corresponding to different surveys. Once the user takes the survey during the subsequent survey session and places the user interface input marker 210-214 at a (new) position that corresponds to the inquiry response position on the user interface slider, the self normalizing survey interface application 112 registers and records the response as a new/updated response data value to be similarly utilized by the self normalizing survey interface application 112 during a future subsequent survey session. In other words, when the user takes the survey or a variant of the survey more than once, each inquiry previously answered in a prior survey is presented with the user interface input marker 210-214 arranged or set in the place on the user interface slider where the user had set it in the most recent prior survey, instead of in a default/blank position.

With reference back to FIG. 1, the self normalizing interface application 112 provides the user with a personal baseline for a given inquiry based on the user's last response, making deviations from the survey response more meaningful since the survey presented during a subsequent survey session takes a response from the survey presented during the prior survey session into account. For example, when the user provides a response indicating a higher score during a subsequent survey session than a prior survey session via the self normalizing survey interface application 112, an improvement is more faithfully quantified than a typical survey interface that provides a blank scale each time the user is presented with the survey (where the user does not likely remember the past ranking).

Specifically, the self-normalizing positioning of the user interface marker references an explicit past instance of the same inquiry corresponding to the user interface input slider that was presented to the user during one or more prior survey sessions. For example, instead of asking directly for a relative judgments (such as scales that offer options like “worse”, “same”, or “better”), the self-normalizing positioning presents a baseline absolute judgment in the form of the previous result of the inquiry and allows the user to make a judgment recorded on the same absolute scale and relative to the user's previous inquiry response(s). Therefore, the self normalizing survey interface application 112 can be utilized by numerous data gathering institutions to record a relative response to one or more inquires within one or more surveys and also to determine the magnitude of change regarding inquiry responses at two or more different intervals of time.

The user is provided with a more personalized survey experience that is presented in a straightforward way that is instantly absorbable and usable since data translation is not required between reading an old inquiry response(s) and inputting an updated inquiry response(s). Additionally, statistical “noise” of users making errors in remembering/guessing past responses is diminished since the self-normalizing positioning of the user interface input marker allows for a more quantifiable breakdown of high level trends using underlying intra-user comparisons built into data. Since the scale is continuous, it allows for even small changes relative to past states that may be lost in a scale that uses discrete values.

The self normalizing survey interface application 112 is executed on one or more stationary computing devices 124 (e.g., a desktop computer) and/or portable electric devices 120 (e.g., a handheld device, a mobile device, a smart phone, a laptop, a tablet, and an e-reader.) In an exemplary embodiment, the self normalizing survey interface application 112 and/or one or more of the components of the self normalizing survey interface application 112 can be installed externally from the memory of the portable electronic device 120 and/or the stationary computing device(s) 124. For example, the self normalizing survey interface application 112 can include a web based application that is accessed by a communication device (not shown) of the portable electronic device(s) 120 and/or the stationary computing device(s) 124. As a web based application the self normalizing survey interface application 112 can be installed on one or more servers 122 that can include application and web servers that host the self normalizing survey interface application 112 to be accessed by numerous portable electronic devices 120 and/or stationary computing devices 124 via the internet using a web browser.

In an alternate embodiment, the self normalizing survey interface application 112 is a software application that is installed directly onto memory (not shown) of the stationary computing device(s) 124 and/or the portable electronic device(s) 120. In other embodiments, the self normalizing survey interface application 112 can include a cloud based application that resides on an external host server such as the server(s) 122 but is accessed through a viewer application that is installed on the memory of the portable electronic device(s) 120 and/or the stationary computing device(s) 124.

In one embodiment of the self normalizing survey interface application 112, during an initial use of the self normalizing survey interface application 112, the user is presented the survey user interface 112 that allows the user to create a user account profile. The user account profile can include a username and password that is tied to the user and that can be utilized by the self normalizing survey interface application 112 as a unique identifier that corresponds to the user during subsequent survey sessions.

In an alternate embodiment, the self normalizing survey interface application 112 analyzes and determines an IP address of the portable electronic device 120 or the stationary computing device 124 that the user is using to access the self normalizing survey interface application 112. The self normalizing survey interface application 112 can then utilize the IP address of the portable electronic device 120 or the stationary computing device 124 that the user is using as a unique identifier that corresponds to the user, the portable electronic device 120 or the stationary computing device 124 during subsequent survey sessions. In yet an alternate embodiment wherein the self normalizing survey interface application 112 is a web based application, a web browser cookie that holds data that is specific to the user can be utilized as the user and/or the portable electronic device 120 or the stationary computing device 124 during subsequent survey sessions. In an alternate embodiment, portable electronic device 120 and/or stationary computing device 124 operating system login and/or other data that is linked to the user can be utilized as the unique identifier.

In the exemplary embodiment shown in FIG. 1, the survey interface application database infrastructure 102 resides on the one or more servers that include one or more database servers. In an alternate embodiment, the survey interface application database infrastructure resides on the server(s) 122 that store and execute the self normalizing survey interface application 112. The survey interface application database infrastructure 102 includes one or more databases 104 that can consist of a federated database(s) that include sections or autonomous database systems for user level data 106 and inquiry level data 108. The user level data 106 can include data that is tied to users of the self normalizing survey interface application 112. The user level data 106 is created, populated, and/or retrieved by the components of the self normalizing survey interface application 112.

The user level data 106 can include but is not limited to user profile data (username/password), one or more unique identifiers that corresponds to the user, the portable electronic device 120 or the stationary computing device 124, one or more data entities that are linked to the user, one or more data records that are included within the one or more data entities that correspond to one or more surveys, the IP address of the portable electronic device 120 or the stationary computing device 124 used to utilize the self normalizing survey interface application 112, web cookie data linked to the web browser being utilized to execute the self normalizing survey interface application 112, etc. The inquiry level data 108 includes but is not limited to survey data that includes a survey identification number that is linked to the survey, survey graphical user interface data which is utilized by the survey user interface 118 to provide the look and feel of the survey including the user interface input slider (i.e., colors, style, font, etc.) and user interface input marker. In addition, the inquiry level data 108 includes one or more inquires along with inquiry identification numbers that are linked to each inquiry, along with any other graphical user interface data that include any customizations for each inquiry that apply to the user interface input slider and/or user interface input marker.

The self normalizing survey interface application 112 (and its components) can connect to the survey interface application database infrastructure 102 in order to supply/access user level data 106 and access inquiry level data 108 within the one or more databases 104 in order to provide self normalizing functionality. Data gathering institutions can also connect to the survey interface application database infrastructure 102 in order to supply the inquiry level data 108 within the one or more databases 104. For example, various types of data gathering institutions (e.g., corporations, political entities, governmental entities, etc.) can provide inquiry level data 108 to the one or more databases 104 of the survey interface application database infrastructure 102 in order to supply surveys and underlying inquiries to be utilized by the self normalizing survey interface application 112.

In one embodiment, both the self normalizing survey interface application 112 and data gathering institution computing systems can access the survey interface application database infrastructure through a direct secure internet connection (e.g., via web based application programming interface, via a middle-tier authentication server, external secure connection). For example, with respect to the data gathering institutions, the secure connection can provide a web based gateway to access the survey interface database infrastructure 102 in order for data gathering institutions to supply and extract inquiry level data 108 to and from the self normalizing survey interface application 112. The self normalizing survey interface application 112 can utilize the secure connection to provide the user with surveys and inquiries, and record the user's answers to be shown back to them during subsequent sessions. In an alternate embodiment, the survey interface application database infrastructure 102 can include security infrastructure (not shown) that can be configured to accept extranet connections from (security infrastructure and computing systems) the server(s) 122 hosting the self normalizing survey interface application 112 and/or data gathering institution computing systems to access the inquiry level data 108 and the user level data 106 residing on the databases 104.

Upon the user's initial use of the self normalizing survey interface application 112, the survey user interface 118 is presented to the user which includes an initial survey session. As will be described in more detail below, as the user accesses the self normalizing survey interface application 112, to start a survey session the self normalizing survey interface application 112 connects to the survey interface application database infrastructure 102 and accesses the inquiry level data 108 that was provided by the data gathering institutions. The inquiry level data 108 is queried in order to access and present the survey and underlying inquiries that correspond to one or more data gathering institutions (that the survey is being provided for). Once the inquiry level data 108 is accessed, it is presented via the survey user interface 118.

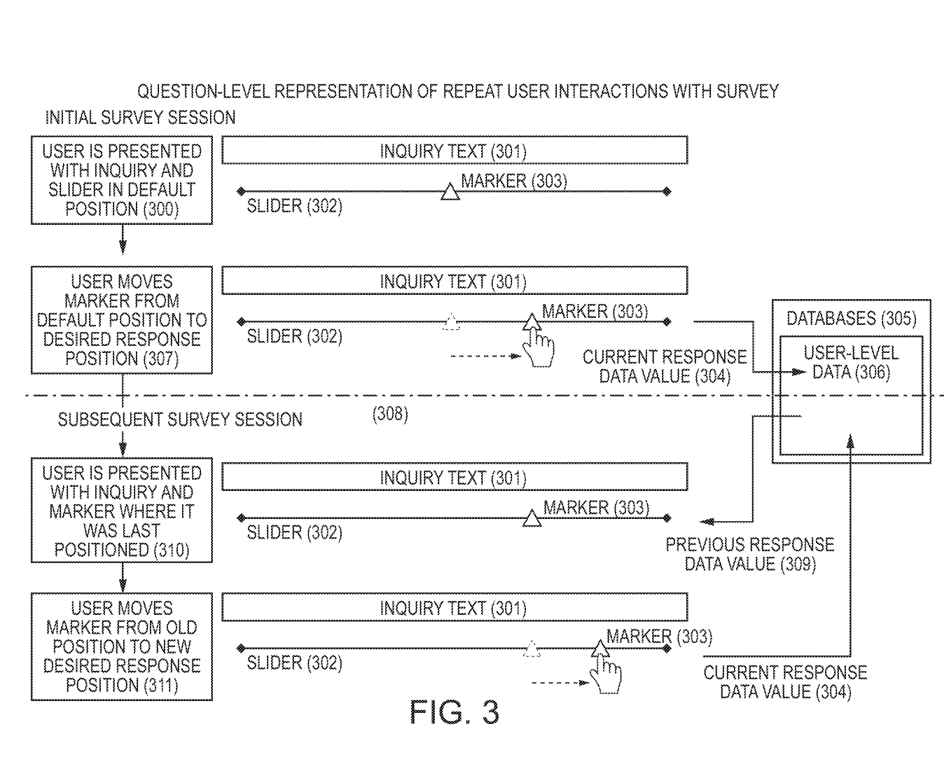

FIG. 3 is a process flow diagram of an overview of exemplary details regarding the position of a user interface input marker during an initial survey session and a subsequent survey session. As discussed above, during the initial survey session, at 300, the user is presented with inquiry text and/or audio and/or video 301 and the user interface input marker 303 is shown at a default start position of the user interface input slider 302. The user is then provided the ability to reposition (move) the user interface input marker 303 by scrolling, drag and drop, and/or other input means at a plurality of inquiry response positions by the user as an inquiry response to each inquiry within a survey. At 307, once the user repositions the user interface input marker 303 at an inquiry response position of the user interface input slider 302 for each inquiry, the survey marker reception module registers a response that corresponds to the final inquiry response position of the user input marker 303 on the user interface input slider 302.

In an exemplary embodiment, the responses to all answered inquiries are registered after the user inputs a survey completion user interface icon. For example, the survey completion user interface icon can be presented as a ‘Survey Submit’ user interface button that signifies the completion of the survey. In one embodiment, the response is registered for each inquiry after a predetermined amount of time of inactivity (e.g., five seconds) after the user interface marker 303 is moved and placed (at the final inquiry response position) at an inquiry response position of the user interface slider 302. In an alternate embodiment, the response is registered after the user double clicks the user interface input marker 302 to finalize an answer to each inquiry.

The survey marker reception module evaluates the inquiry response position (i.e., the registered response to each inquiry) and determines a current response data value 304. In one embodiment, the current response data value 304 is an encrypted data value that corresponds to the specific inquiry response position on the continuous scale of the user interface input slider 302. In an alternate embodiment, the current response data value 304 can include textual and/or numerical data that corresponds to the labels associated with the user interface input slider. In one embodiment, upon determining the current response data value 304 that corresponds to the user's response of the initial survey session, the survey marker reception module connects to the survey interface application database infrastructure and accesses the one or more databases 305. As will be described in more detailed below, the survey marker reception module records the current response data value 304 within user level data 306. The user level data 306 can be queried by the data gathering institutions in order to obtain the current response data value 304 in order for the data gathering institutions to run analysis and/or reports based on the user's inquiry responses within the survey.

In an exemplary embodiment, when the user utilizes the self normalizing survey interface application during the subsequent survey session 308, the user is presented with the survey user interface 118 that displays the survey the user took during the initial survey session (or any previous survey session). The survey marker position output module connects to the survey interface application database infrastructure and performs a query on the databases 305 in order to acquire the previous response data value 309 from the user level data 306. Once the previous response data value 309 is obtained, the survey marker position output module analyzes the previous response data value 309 in order to determine the user's response position on the user interface marker 303 for each inquiry during the previous (initial) survey session. As shown at 310, the user is then presented with the user interface marker 303 positioned in a self normalized position (i.e., where it was last positioned by the user at 307). In an exemplary embodiment, when the user utilizes the self normalizing survey interface application during the subsequent survey session 308 the user is presented with the survey user interface 118 that displays the survey the user took during the initial survey session (or any previous survey session).

During the subsequent survey session 308, the user can complete the survey and can once again move the user input marker 303 from the previous response position (e.g., at 310) to a new response position on the user interface input slider 302. At 311, the user moves the user input interface marker 303 to the new desired response position on the user interface input slider 302. Upon determining the current response data value 304 that corresponds to the user's response of the survey session 311, the survey marker reception module connects to the survey interface application database infrastructure and accesses the one or more databases 305. The survey marker reception module then updates the current response data value 304 within user level data 306 that can be utilized to provide the self normalizing user interface input marker 303 during future (subsequent) survey sessions.

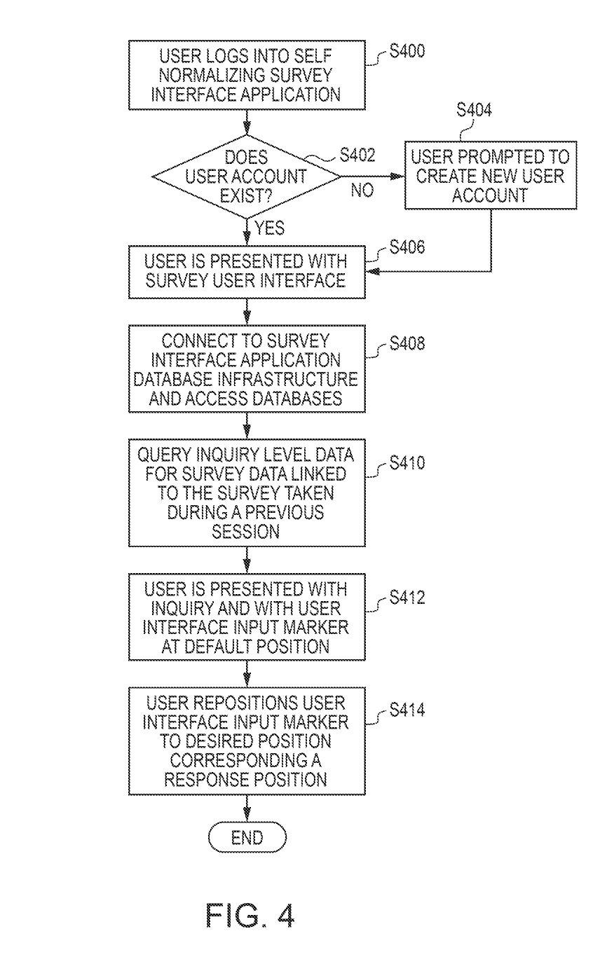

FIG. 4 is a process flow diagram of a method utilized during an initial survey session of an exemplary embodiment of the self-normalizing survey interface application. The method begins as the user executes the self normalizing survey interface application 112 by executing the application (installed) locally, remotely, or via a web interface via the portable electronic device 120 and/or stationary computing device 124. At S400, the user attempts to log into the self normalizing survey interface application 112 to take a survey during an initial survey session. The user is presented with a login user interface that enables the user to type in user account credentials (username and password) in order to login to the self normalizing survey interface application 112. The user is also presented with a user interface icon that enables the user to create a new user account including new user account credentials in order to login to the self normalizing survey interface application 112 in the event that the user already did not previously create a user account.

At S402, it is determined if the user account exists. For example, if the user inputs the user interface icon to enable the user to create the new user account, it is determined that the user account does not exist (at S402) and the user is prompted to create a new user account at S404. In an exemplary embodiment, in addition to the user credentials, the user account can include user demographic information, user preferences, user personal data, and/or other data that is pertinent to one or more surveys and/or data gathering institutions. In one embodiment, as the user logs into the self normalizing survey interface application 112, the survey user interface 118 provides an input box and/or a drop down box that the user can utilize to pick a survey (tied to a survey identification number). In an alternate embodiment, the user is provided the survey link to a specific survey (tied to a survey identification number) within an e-mail link or a website link that automatically executes the self normalizing survey interface application 112 with the corresponding survey. If it is determined (at S402) that the user account exists or the user creates the new user account (at S404), the survey marker survey marker reception module 114 and the survey marker position output module 116 connect to the survey interface application database infrastructure 102 and access the databases 104 at S406.

At S410, the survey marker position output module 116 queries the inquiry level data 108 for survey data that is linked to the survey taken during the previous survey session (based on the survey identification number). The survey marker position output module 116 also provides inquiry data to the survey user interface 118 that includes the one or more inquires that are included within the survey. At S412, the user is presented with the survey on the survey user interface 118 that includes one or more inquires and the user interface input marker placed at the default position of the user interface input slider. At S414, the user repositions (e.g., drags) the user interface input marker to a desired position corresponding to the (final) inquiry response position on the user interface input slider.

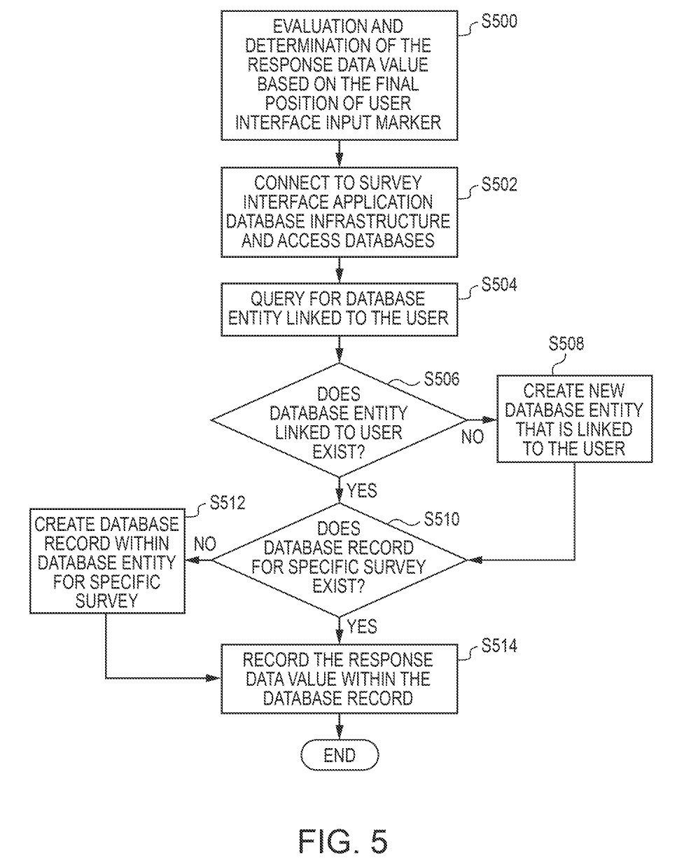

FIG. 5 is a process flow diagram of a method utilized to record a response data value that corresponds to the position of the user interface input marker from a prior survey of an exemplary embodiment of the self-normalizing survey interface application 112. Once the user completes the survey during a survey session (including the initial survey session discussed with regards to FIG. 4), at S500, the survey marker reception module 114 conducts an evaluation and determination of the response data value(s) based on the last (final) response positions of the user interface marker at each inquiry. At S502, the survey marker reception module 114 connects to the survey interface application database infrastructure 102 and accesses the databases 104. At S504, the survey marker reception module 114 queries the databases 104 for the database entity that is linked to the user. In one embodiment, upon the user's first use of the self normalizing survey interface application 112, the survey marker reception module 114 creates the database entity within the user level data 106. In an exemplary embodiment, the database entity linked to the user can include one or more database records that each correspond to one or more distinct surveys.

At S506, it is determined if the database entity linked to the user exists (i.e., if the user utilized the self normalizing survey interface application 112 before or if this is the user's first use). If it is determined that the database entity linked to the user does not exist (as S506), the survey marker reception module 114 creates a new database entity that is linked to the user by utilizing the user account at S508. For example, the database entity can be named and linked to the user by the username corresponding to the user's account. In an alternate embodiment, the database entity can be named and linked to the portable electronic device 120 and/or the stationary computing device 124 by the IP address. Additional embodiments of the self normalizing user interface application 112 can utilize web cookies, operating system login information, and/other identification means that can be utilized to name and link the database entity.

If it is determined that the database entity linked to the user exists (at step 510) or the survey marker reception module 114 creates a new database entity that is linked to the user (at S508), it is further determined if the database record exists for the survey that is being taken at 5510. If it is determined that the database record for the survey being taken does not exist (at S510), the survey marker reception module 114 creates a database record corresponding to the survey being taken within the user level data 106 of the database 104. In an exemplary embodiment, the database record includes survey data and inquiry data that include inquiry response data values that correspond to one or more surveys that were completed by the user (to be utilized during subsequent survey sessions). The database record can also include a description of the surveys and/or underlying inquires. For example, in one embodiment, the database record can include a description that includes the survey name, a survey identification number, and a time stamp corresponding to completion of each inquiry and/or the completion of the survey. The database record can also contain some data that identifies the user such as the user account data.

If it is determined that a database record does exist for a specific survey (at S510), (i.e., the user took the survey at a previous point in time and this is a subsequent survey session), or if the database record was created (at S512), the survey marker reception module 114 records the response data values that correspond to each of the one or more inquires within the database record at S514. Specifically, the survey marker reception module 114 accesses the databases 104 and queries the user level data 106 for the data entity linked to the user. The survey marker reception module 114 then overwrites and/or amends applicable response data values (corresponding to inquires that that received the user's response) within the database record (included within the database entity linked to the user). In an alternate embodiment, existing database records (from prior survey sessions) are retained within a prior survey session section (e.g., directory) of the database entity within the user level data 106 and the (current) response data value is saved within a new database record. This configuration can be utilized to provide an embodiment of the survey user interface 118 wherein more than one user interface input marker is shown at the self normalized position to present numerous prior survey session responses to the specific survey and/or one or more inquires.

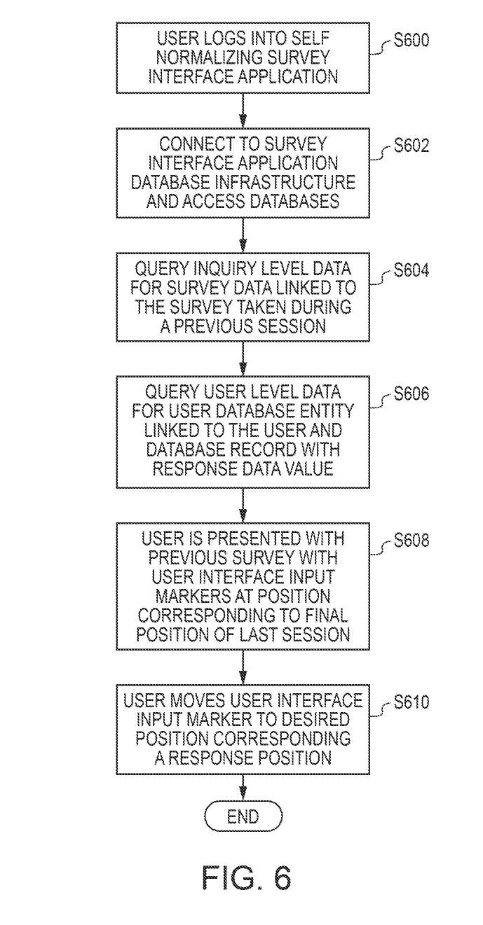

FIG. 6 is a process flow diagram of a method utilized during a subsequent survey session of an exemplary embodiment of the self-normalizing survey interface application. At S600, the self normalizing survey interface application 112 is started using the user identification in order to utilize the self normalizing survey interface application 112 to take a survey that the user has taken during a previous survey session. At S602, the survey marker position output module 116 connects to the survey interface application database infrastructure 102 and accesses the databases 104. At S604, the survey marker position output module 116 queries the inquiry level data 108 for survey data that is linked to the survey taken during the previous survey session (based on the survey identification number). The survey marker position output module 116 also provides inquiry data to the survey user interface 118 that includes the one or more inquires that are included within the survey. At S606, the survey marker position output module 116 queries the user level data for the database entity linked to the user and the database record that contains the response data value corresponding to the prior survey that is being displayed via the survey user interface 118.

Upon retrieving the database record that contains the response data value that corresponds to the prior survey that is being displayed via the survey user interface 118, at S608, the user is presented with the previous survey wherein the user interface input marker(s) is positioned at a self normalizing position that corresponds to the inquiry response position selected by the user for one or more underlying inquires included within the survey during one or more prior survey sessions. In other words, the user is presented with the survey user interface 118 that presents the previous survey with the user interface input marker at the inquiry response position(s) corresponding to the (final) inquiry response position(s) selected by the user during the last survey session.

At S610, the user moves the user interface input marker (during the current session) to the desired position corresponding to a response position. It is to be appreciated that the steps S500-S514 shown in FIG. 5 discussed above are conducted after the user's completion of the current survey in order for the survey marker position output module 116 to present the user interface input marker at a self normalized position during the future (subsequent) session. Specifically at S514, when the survey marker reception module 114 records the response data value within the database record, the existing database record is updated (i.e., overwritten) since the database record is already located within the database entity from the last survey session.

As discussed, various embodiments of the self normalizing survey interface system 100 can be utilized to provide the user with a self normalized survey. It is to be appreciated that in addition to a stand alone local or web-based application, the self normalizing survey interface application 112 can be utilized on different types of platforms, computing infrastructure, and/or devices that are in production and that are not yet in production. For example, the self normalizing survey interface application 112 can be executed on a social media platform to be utilized as a social media platform specific application or plug-in.

The embodiments discussed herein can also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data. Computer readable storage media excludes non-transitory tangible media and propagated data signals.

It will be appreciated that various implementations of the above-disclosed and other features and functions, or alternatives or varieties thereof, can be desirably combined into many other different systems or applications. Also that various presently unforeseen or unanticipated alternatives, modifications, variations or improvements therein can be subsequently made by those skilled in the art which are also intended to be encompassed by the following claims.

What is claimed:

1. A method for graphically presenting a survey interface to a user, the method comprising:
during a survey session, graphically presenting the user with an inquiry and a corresponding user interface input slider via a self normalizing survey interface application, wherein the user interface input slider includes a user interface input marker configured to be selectively positioned at one of a plurality of inquiry response positions by the user as an inquiry response;
recording the inquiry response position of the user interface input marker on the user interface input slider selected by the user in response to the inquiry as a response data value; and
in a subsequent survey session of the user via the self normalizing survey interface application, presenting the user with a subsequent inquiry and corresponding user interface input slider, wherein the user interface input marker is positioned at a self normalizing position that corresponds to the inquiry response position selected by the user during one or more prior survey sessions of the self normalizing survey interface application; and
recording the inquiry response position of the user interface input marker on the user interface input slider selected by the user in response to the subsequent inquiry as a subsequent inquiry response data value to be utilized during one or more subsequent survey sessions of the self normalizing survey interface application.

2. The method of claim 1, further including during an initial survey session, graphically presenting the user with the inquiry and a corresponding user interface input slider by placing the user interface input marker at a default inquiry response start position of a continuous rating scale line segment with the user interface input slider during an initial session of the self normalizing survey interface application.

3. The method of claim 1, wherein the graphically presenting the user with an inquiry and a corresponding user interface input slider includes labeling the user interface input slider with one or more of: accompanying texts, colors, color gradients, numbers, icons, symbols, and pictures.

4. The method of claim 1, wherein the recording the inquiry response position of the user interface input marker on the user interface input slider includes evaluating and determining the response data value based on the final position of the user interface input marker at one of the plurality of inquiry response positions of the user interface input slider.

5. The method of claim 4, wherein the recording the inquiry response position of the user interface input marker on the user interface input slider includes accessing one or more databases associated with the self normalizing survey interface application and creating a database entity that is linked to the user on at the beginning of the user's initial use of the self normalizing survey interface application.

6. The method of claim 6, wherein the recording the inquiry response position of the user interface input marker on the user interface input slider includes accessing one or more databases associated with the self normalizing survey interface application and recording the response data value within a database record included within the database entity that is linked to the user.

7. The method of claim 1, wherein the presenting the user with a subsequent inquiry and corresponding user interface input slider includes presenting the user with the same inquiry corresponding to the user interface input slider that was presented to the user during one or more prior survey sessions.

8. The method of claim 1, further including positioning the user interface input marker in a self normalizing position by accessing one or more databases associated with the self normalizing survey interface application and providing a query to acquire the database record containing the response data value from one or more prior survey sessions included within the database entity that is linked to the user.

9. The method of claim 1, wherein the recording the inquiry response position of the user interface input marker on the user interface input slider by the user in response to the subsequent inquiry includes accessing one or more databases associated with the self normalizing survey interface application and recording an updated response data value within the database record included within the database entity that is linked to the user.

10. A system for graphically presenting a survey interface to a user, the system comprising:
a self normalizing survey interface application that is executed on a plurality of electronic devices;
a survey user interface that is included as a user interface of the self normalizing server interface application for graphically presenting the user with an inquiry and a corresponding user interface input slider during a survey session, wherein the user interface input slider includes a user interface input marker configured to be selectively positioned at one of a plurality of inquiry response positions by the user as an inquiry response;
a survey marker reception module that is included as a module of the self normalizing server interface application that records the inquiry response position of the user interface input marker on the user interface input slider selected by the user in response to the inquiry as a response data value;
a survey marker position output module that is included as a module of the self normalizing server interface application that presents the user with a subsequent inquiry and corresponding user interface input slider during a subsequent survey session, wherein the user interface input marker is positioned at a self normalizing position that corresponds to the inquiry response position selected by the user during one or more prior survey sessions with the self normalizing survey interface application and the survey marker reception module records the inquiry response position of the user interface input marker on the user interface input slider selected by the user in response to the subsequent inquiry as a subsequent inquiry response data value to be utilized during one or more subsequent survey sessions of the self normalizing survey interface application.

11. The system of claim 10, further including the self normalizing survey interface application graphically presenting the user with the inquiry and a corresponding user interface input slider by placing the user interface input marker at a default inquiry response start position of a continuous rating scale line segment of the user interface input slider during an initial survey session of the self normalizing survey interface application.

12. The system of claim 10, wherein the survey marker reception module evaluates and determines the response data value based on the final position of the user interface input marker at one of the plurality of inquiry response positions of the user interface input slider.

13. The system of claim 12, wherein the survey marker reception module accesses the one or more databases associated with the self normalizing survey user interface application and creates a database entity that is linked to the user at the beginning of the user's initial use of the self normalizing survey interface application.

14. The system of claim 13, wherein the survey marker reception module accesses the one or more databases associated with the self normalizing survey user interface application and records the response data value in a database record included within the database entity that is linked to the user.

15. The system of claim 10, wherein the survey marker position output module presents the user with the same inquiry corresponding to the user interface input slider during a subsequent survey that was presented to the user during one or more prior survey sessions.

16. The system of claim 10, further including the survey marker position output module positioning the user interface input marker in the self normalizing position by accessing one or more databases associated with the self normalizing survey interface application and providing a query to acquire the database record containing the response data value from one or more prior survey sessions included within the database entity that is linked to the user.

17. The system of claim 10, wherein the survey marker reception module accesses one or more databases associated with the self normalizing survey interface application and records an updated response data value within the database record included within the database entity that is linked to the user.

18. A computer readable medium comprising instructions that when executed by a processor perform actions comprising:
during a survey session, graphically presenting the user with an inquiry and a corresponding user interface input slider via a self normalizing survey interface application, wherein the user interface input slider includes a user interface input marker configured to be selectively positioned at one of a plurality of inquiry response positions by the user as an inquiry response;
recording the inquiry response position of the user interface input marker on the user interface input slider selected by the user in response to the inquiry as a response data value; and
in a subsequent survey session of the user via the self normalizing survey interface application, presenting the user with a subsequent inquiry and corresponding user interface input slider, wherein the user interface input marker is positioned at a self normalizing position that corresponds to the inquiry response position selected by the user during one or more prior survey sessions of the self normalizing survey interface application; and
recording the inquiry response position of the user interface input marker on the user interface input slider selected by the user in response to the subsequent inquiry as a subsequent inquiry response data value to be utilized during one or more subsequent survey sessions of the self normalizing survey interface application.

19. The computer readable medium of claim 18, wherein the recording the inquiry response position of the user interface input marker on the user interface input slider includes evaluating and determining the response data value based on the final position of the user interface input marker at one of the plurality of inquiry response positions of the user interface input slider.

20. The computer readable medium of claim 18, further including positioning the user interface input marker in a self normalizing position by accessing one or more databases associated with the self normalizing survey interface application and providing a query to acquire the database record containing the response data value from one or more prior survey sessions included within the database entity that is linked to the user.
